(19) United States
(12) Patent Application Publication
(10) Pub. No.: US 2016/0050683 A1
(43) Pub. Date: Feb. 18, 2016

(54) MULTIBAND OPERATION OF A SINGLE WI-FI RADIO

(71) Applicant: HEWLETT-PACKARD DEVELOPMENT COMPANY, L.P., Houston, TX (US)

(72) Inventors: Anil Gupta, Littleton, MA (US); Sung-Ju Lee, Palo Alto, CA (US); Roger D. Sands, Littleton, MA (US); Stephane Laroche, St. Laurent, CA (US)

(21) Appl. No.: 14/777,475

(22) PCT Filed: Mar. 15, 2013
(86) PCT No.: PCT/US2013/032085

§ 371 Date: Sep. 15, 2015

(51) Int. Cl. H04W 72/12

(52) U.S. Cl. CPC H04W 72/12; H04W 84/12

(57) ABSTRACT

Multiband operation of a single Wi-Fi radio is described. Some examples can include operating a first radio frequency band on the single Wi-Fi radio of an access point. The method can include switching, based on client device traffic patterns, to a second radio frequency band on the single Wi-Fi radio of the access point.

### BACKGROUND

Networks can be utilized to stream data, such as streaming movies, music, and other media. In some instances, multiple electronic devices (e.g., client devices) may be associated with a single network device (e.g., access point (AP)). APs may operate on various radio frequencies. Modern APs are built to support standards (e.g., defined by institute of electrical and electronics engineers (IEEE) 802.11) for sending and receiving data using radio frequencies in particular radio frequency bands (e.g., 2.4, 3.6, 5 and 60 Gigahertz (GHz)). Client devices may include a network interface controller such as a wireless network card to facilitate communication with the AP over these radio frequency bands. Client devices of differing types and ages may have disparate abilities to support communication over a given radio frequency band or bands. According to some previous approaches, the AP may include multiple radios in order to provide concurrent multiband operation to support a variety of client devices.

### BRIEF DESCRIPTION OF THE DRAWINGS

FIG. 1 illustrates an example of a network site for multiband operation of a single Wi-Fi radio according to the present disclosure.

FIG. 2 is a flow chart illustrating an example of a method for multiband operation of a single Wi-Fi radio according to the present disclosure.

FIG. 3 illustrates a block diagram of an example of a system for multiband operation of a single Wi-Fi radio according to the present disclosure.

FIG. 4 illustrates a block diagram of an example access point according to the present disclosure.

### DETAILED DESCRIPTION

An access point (AP) can be a device that allows client devices to connect to a network. This can include wireless APs that allow wireless devices to connect to a wired network. The AP can utilize Wi-Fi or related standards in providing the connection. These standards (e.g., IEEE 802.11) can specify parameters for implementing wireless local area network (WLAN or Wi-Fi) computer communication in various radio frequency bands (e.g., 2.4, 3.6, 5 and 60 Gigahertz (GHz)).

A given set of standards (e.g., IEEE 802.11) can consist of a family of half-duplexed over-the-air modulation techniques that use the same basic protocol. Over time, the protocols can be amended (e.g., 802.11a, 802.11b, 802.11g, and 802.11n). The amendments can incorporate standards for computer communication on different radio frequency bands (e.g., 802.11a-5 GHz, 802.11b 2.4 GHz, 802.11g 2.4 GHz, 802.11n-2.4 GHz and 5 GHz).

Client devices can include wireless network interface controllers (e.g., wireless network card) that implement standards (e.g. IEEE 802.11) to associate with an AP to access a network. The specific standards/amendments that the wireless network interface controller is compatible with can influence how, or even if, interaction with a specific AP will proceed.

The popularity and availability of wireless client devices (e.g., laptops, tablets, smartphones, video game systems, etc.) has exploded in recent years. As a result, the population now utilizes a wide variety of wireless client devices. The variety of wireless client devices includes devices with varying levels of technological capabilities and compatibilities. For instance, some client devices can be wireless devices (e.g., early smartphones, student grade laptops, etc.) which support communication only on the 2.4 GHz radio frequency band of the radio spectrum. Other wireless devices (e.g. modern smartphones, professional grade laptops, etc.) can support communication over both 2.4 and 5 GHz radio frequency bands.

With an increased number of wireless client devices with diverse technological capabilities and compatibilities present in the population, it has become important for public Wi-Fi hotspot providers to continue to offer backwards compatibility for both the older and newer wireless client devices. For instance, in the hospitality industry, hospitality service providers may wish to provide an access point which is compatible with both the 2.4 GHz radio frequency band of the radio spectrum and the 5 GHz radio frequency band of the radio spectrum. In this way, hospitality service providers can allow customers with 2.4 GHz compatible wireless client devices to access a network (e.g., Internet), and customers with 5 GHz compatible wireless client devices to access the same network. While many 5 GHz compatible wireless client devices are also compatible with the 2.4 GHz radio frequency band, it is not an optimal radio frequency band for such devices because the 2.4 GHz radio frequency band suffers shortcomings. For instance the 2.4 GHz radio frequency band has become crowded and is plagued by interference from non-Wi-Fi devices such as IEEE 802.15.4 transceivers, cordless telephones, baby monitors, microwave ovens, etc. Furthermore, the 2.4 GHz radio frequency band offers only 11 distinct channels (only 3 non-overlapping) while the 5 GHz radio frequency band offers 22 non-overlapping channels (varies by country). Therefore, hospitality service providers may desire to provide 5 GHz compatible wireless client devices a 5 GHz radio frequency band compatible AP for optimal performance of their devices.

APs built to operate multiple radio frequency bands (e.g. 2.4 GHz and 5 GHz radio frequency band) may contain multiple radios (e.g., Wi-Fi chipsets and antennas). Multi-radio APs are expensive hardware and cost-conscious public Wi-Fi hotspot (e.g. a site that offers Internet access of a WLAN through the use of routers connected to a link to an Internet service provider) providers resist investing in the technology. For example, hospitality service providers may opt to utilize a single-radio AP (e.g., an AP capable of operating in only the 2.4 GHz radio frequency band or only the 5 GHz radio frequency band) in order to avoid the increased cost of a multi-radio AP (e.g., an AP capable of operating two radios, one over the 2.4 GHz radio frequency band and one over the 5 GHz radio frequency band).

Many APs are powered via Power-over-Ethernet (PoE). With PoE, an AP only needs an Ethernet connection to be powered as opposed to additional power sources (e.g., batteries, AC/DC, etc.). Providers of Wi-Fi hotspots (e.g., hospitality service providers) can be very sensitive to power use of a given AP and/or the need to provide additional power sources (e.g., an additional power outlet in a guest room) for the AP. Multi-radio APs require more power to operate their multiple radios than their single-radio counterparts and can exceed PoE limits (IEEE 802.3af-2003—up to 15.4 Watts (W), IEEE 802.3at-2009—up to 25.5 W) requiring additional power sources.

By time-slicing between multiple radio frequency bands as taught in the present disclosure, an AP can operate multiple radio frequency bands on a single Wi-Fi radio. As a result, an AP can simultaneously support wireless client devices operating on distinct radio frequency bands while remaining cost and energy efficient.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure. As used herein, the designator “N” particularly with respect to reference numerals in the drawings, indicate that a number of the particular feature so designated can be included with examples of the present disclosure. The designators can represent the same or different numbers of the particular features.

As used herein, “a” or “a number of” an element and/or feature can refer to one or more of such elements and/or features. Further, where appropriate, as used herein, “for example” and “by way of example” should be understood as abbreviations for “by way of example and not by way of limitation.

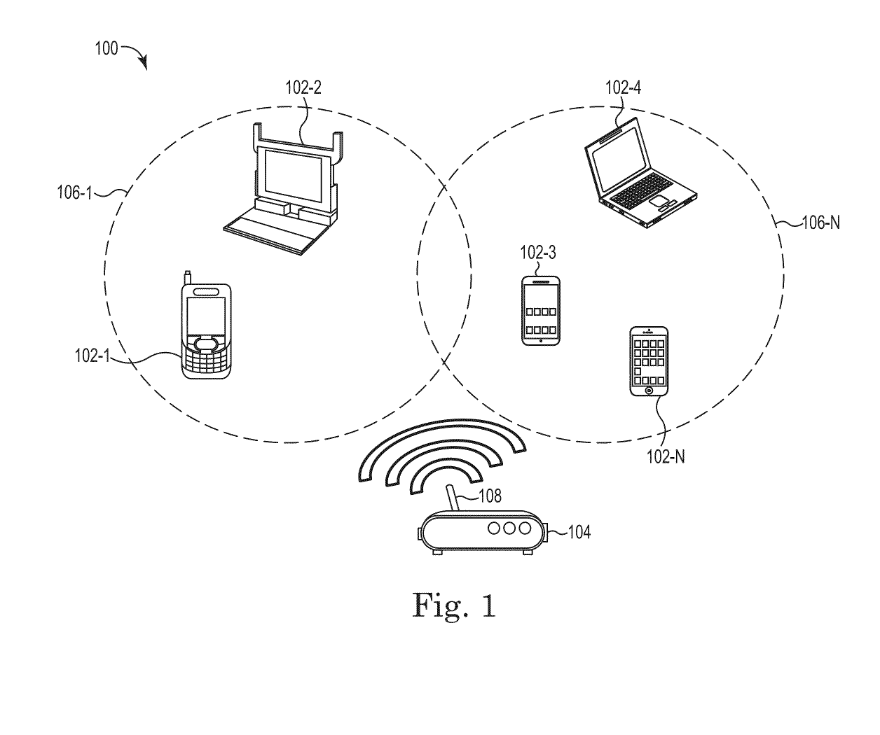

FIG. 1 illustrates an example of a network site 100 for multiband operation of a single Wi-Fi radio 108 according to the present disclosure. The network site 100 can be a hotspot. A number of devices (e.g., wireless client devices 102-1, 102-2, 102-3, . . . , 102-N (hereinafter wireless client devices 102)) can be connected to a network (e.g. a local area network (LAN), wireless local area network (WLAN), and/or Personal Area Network (PAN), among others). FIG. 1 illustrates a number of wireless client devices 102 connected to a WLAN via an AP 104. The AP 104 can be a combination of hardware and program instructions designed to implement its functions. The hardware can include a processor and memory resources while the program instructions are the code stored on the memory and executable by the processor to implement the respective functions. The AP 104 can, for example, be in communication with, physically connected to, and/or part of a router linked to (e.g., directly connected to a wired Ethernet connection) an Internet Service Provider (ISP).

The AP 104 can be a single unit including a router, and Ethernet hub, a firewall, and/or a modem.

The AP 104 can wirelessly connect to wireless client devices 102 through a wireless air interface providing a signal link for sending and/or receiving data to and from the wireless client devices 102 using multiple radio frequencies 106-1 . . . 106-N (e.g., 2.4 GHz and 5 GHz). The AP 104 can utilize standards and frequencies 106-1 . . . 106-N defined by the IEEE. For example, the AP 104 may utilize IEEE 802.11 standards.

The AP 104 can have a single Wi-Fi radio 108 (e.g., Wi-Fi chipsets). For example, an AP 104 can include and/or be associated with a single Wi-Fi radio 108. The Wi-Fi radio 108 can be, for example, any combination of hardware and/or software capable of sending and/or receiving data to and from wireless client devices 102 in the form of radio signals. The single Wi-Fi radio 108 can be used to transmit and receive data in the form of radio signals. The AP 104 can include and/or be in communication with software and/or hardware that can recognize wireless client devices 102, the technological characteristics of wireless client devices 102, the traffic load on certain frequencies 106-1 . . . 106-N, the types of applications being utilized by wireless client devices 102, and/or the parameters of applications being utilized by wireless client devices 102 (e.g., the delay sensitivity of an application, packet transmission timing, etc.), among others.

Wireless client devices 102 (e.g., mobile phones 102-1, student grade laptops 102-2, professional grade laptops 102-4, smart phones 102-3, 102-N, videogame systems, etc.) can have diverse technological characteristics and capabilities for communicating (e.g., translating data into radio signals and transmitting it using the AP 104. For example, particular wireless client devices (e.g., 102-1 and 102-2) can have the ability to support communication with the AP 104 over one type of radio frequency band (e.g., 106-1, 2.4 GHz, etc.), while other wireless client devices (e.g., 102-3, 102-4, 102-N) can have the ability to support communication with the AP 104 over a different type of radio frequency band (e.g., 106-N, 5 GHz, etc.).

The single Wi-Fi radio 108 of the AP 104 can transmit beacon frames at substantially regular time periods to announce the existence of and to synchronize networks. The beacon frames can be received by wireless client devices 102 and can be used in determining with which access point to associate. The number of time units between beacon transmission times is referred to as a beacon interval. The beacon interval can be included in each beacon frame. Each beacon frame can also include a timestamp that is the value of a clock internal to the AP 104 at the actual transmission time of the beacon.

The AP 104 and/or single Wi-Fi radio 108 of the AP can include hardware and/or software that allows the single Wi-Fi radio 108 of the AP 104 to switch between operation of distinct multiple radio frequency bands 106-1 . . . 106-N. This can include switching between transmitting beacon frames over distinct multiple radio frequency bands 106-1 . . . 106-N.

For example, the network site 100 of FIG. 1 illustrates an example network site 100 and hardware/software for operating a first radio frequency band 106-1 on the single Wi-Fi radio 108 of an AP 104. A single Wi-Fi radio 108 can include a Wi-Fi radio 108 that is capable of operating on multiple radio frequency bands 106-1 . . . 106-N, but not two radio frequency bands 106-1 and 106-N simultaneously. Operating a first radio frequency band 106-1 over the single Wi-Fi radio 108 of the AP 104 can include operating a 2.4 GHz radio frequency band over the single Wi-Fi radio 108 of the AP 104. In this manner, the single Wi-Fi radio 108 can provide a signal link between the AP 104 and wireless client devices 102 capable of communication over the 2.4 GHz radio frequency band.

The example network site 100 can include hardware/software for operating a second radio frequency band 106-N on the single Wi-Fi radio 108 of the AP 104. Operating a second radio frequency band 106-N over the single Wi-Fi radio 108 can include operating a 5 GHz radio frequency band over the same single Wi-Fi radio 108 of the AP 104 that operated the first radio frequency band 106-1. In this manner, the single Wi-Fi radio 108 of an AP 104 can provide a signal link between the AP 104 and wireless client devices 102 capable of communication over the 5 GHz radio frequency.

The example network site 100 can include hardware/software for switching between the first radio frequency band 106-1 and the second radio frequency band 106-N on the single Wi-Fi radio 108 of the access point 104 based at least in part on airtime fairness and wireless client device 102 application delay sensitivity. For example, the single Wi-Fi radio 108 can be switched from a 2.4 GHz radio frequency to a 5 GHz radio frequency band, and vice versa, based at least in part on airtime fairness and wireless client device 102 application delay sensitivity.

Airtime fairness can include the principle that faster wireless client devices 102 and/or radio frequency bands 106 should be allowed to use more airtime that slower wireless client devices 102 and/or radio frequency bands 106. Airtime can include time and/or portions of time spent operating a particular radio frequency band 106 on the single Wi-Fi radio 108 of the AP 104. Faster wireless client devices 102 can include wireless client devices 102 that support higher data transmission rates.

Switching between the first radio frequency band 106-1 and second radio frequency band 106-N on the single Wi-Fi radio 108 of the access point 104 based at least in part on airtime fairness can include scheduling radio frequency band 106 operation based at least in part on a transmission rate of a wireless client device 102 on each radio frequency band 106. Scheduling radio frequency band 106 operation based on a transmission rate of a wireless client device 102 on each radio frequency band 106 can include scheduling longer operation (e.g., more airtime) on a radio frequency band 106 associated with a high (e.g., relative to a standard, relative to other wireless client devices 102 on the WLAN) transmission rate wireless client device 102. For example, a 5 GHz radio frequency band can be operated more frequently than a 2.4 GHz radio frequency band because the wireless client device 102 transmitting or receiving data over the 5 GHz radio frequency band is capable of higher transmission/reception rates than those operating over the 2.4 GHz radio frequency band on the same single Wi-Fi radio 108 of the AP 104.

Conversely, scheduling radio frequency band 106 operation based on a transmission rate of a wireless client device 102 on each radio frequency band 106 can include scheduling shorter operation (e.g., less airtime) on a radio frequency band 106 associated with a high (e.g., relative to a standard, relative to other wireless client devices 102 on the WLAN) transmission rate wireless client device 102. For example, a 5 GHz radio frequency band can be operated less frequently than a 2.4 GHz radio frequency band because a high-transmission rate wireless client device 102 transmitting or receiving data over the 5 GHz radio frequency band is capable of transmitting/receiving more data in less time than those operating over the 2.4 GHz radio frequency band.

Switching between the first radio frequency band 106-1 and the second radio frequency band 106-N on the single Wi-Fi radio 108 of the access point 104 based at least in part on airtime fairness can include scheduling radio frequency band 106 operation based at least in part on the ability of a radio frequency band 106 to support high data transmission rates. This can include scheduling longer operation on a radio frequency band 106 that supports higher data transmission rates than another radio frequency band 106 operating on the single Wi-Fi radio 108 of the AP104. A 5 GHz radio frequency band, for example, can be scheduled for longer operation than a 2.4 GHz radio frequency band on the single Wi-Fi radio 108 of an AP 104 because the 5 GHz radio frequency band supports higher data transmission rates.

Application delay sensitivity can include the sensitivity of an application operating over a radio frequency band 106 on the single Wi-Fi radio 108 of an AP 104 to delays in the transmission of data associated with the application. A delay-sensitive application can include an application that is not able to function properly when subject to delays in data transmission. For example, a Voice over IP (VoIP) application can be a delay sensitive application because it does not function properly when subject to delays in data transmission. A delay-insensitive application can include an application which is able to function properly when subject to delays in data transmission. For example, a peer-to-peer (P2P) file sharing application can be a delay insensitive application because it can still function properly when subject to delays in data transmission.

Switching between the first radio frequency band 106-1 and the second radio frequency band 106-N on the single Wi-Fi radio 108 of the AP 104 based at least in part on wireless client device 102 delay sensitivity can include scheduling radio frequency band 106 operation based on a type of application utilized by a wireless client device 102 and a sensitivity of the application to a delay in data transmission.

The type of application utilized by a wireless client device 102 can be the specific identity of the application being utilized, a category (e.g., VoIP, P2P, etc.) of application associated with the application being utilized, parameters (e.g., requirements of the application for proper functioning) associated with the application being utilized, and/or client device indicated parameters associated with the application (e.g., quality settings, etc.), among others. Scheduling radio frequency band 106 operation based on the type of application utilized by a wireless client device 102 can include operating longer and/or more frequently on a radio frequency band 106 supporting a type (e.g., a preferred type, having specific parameters, etc.) of application.

A sensitivity of the application to delay in data transmission can be based on characteristics associated with the application. The sensitivity of the application to delay in data transmission may be based on known and/or determined sensitivities of the specific application and/or applications of the same type. Scheduling radio frequency band 106 operation based on the sensitivity of an application utilized by a wireless client device 102 to delay can include operating longer and/or more frequently on a radio frequency band 106 supporting a delay-sensitive application.

Scheduling radio frequency band 106 operation based on a type of application utilized by a wireless client device 102 and the sensitivity of the application to the delay in transmission can include scheduling the switch between the first radio frequency band 106-1 and the second radio frequency band 106-N on the single Wi-Fi radio 108 of the access point to occur between transmissions of data (e.g., packets, frames, etc.). For example, if a delay-sensitive VoIP application generates packets every 30 milliseconds, operation of a radio frequency band 106 not associated with the VoIP application may be scheduled in the intervening time between packet generation and/or reception by the application.

Switching between a first radio frequency band 106-1 and a second radio frequency band 106-N on the single Wi-Fi radio 108 of the access point 104 based at least in part on airtime fairness and wireless client device 102 application delay sensitivity can include preferentially scheduling switching. For example, scheduling switching so that a wireless client device 102 capable of higher transmission rates and/or operating a delay-sensitive application (e.g., VoIP, etc.), receives more airtime than a wireless client device 102 capable of lower transmission rates and/or operating a delay-insensitive application (e.g., P2P, etc.). This can include operating, on a single Wi-Fi radio 108 of an AP 104, on a first radio frequency band 106-1 associated with a high speed wireless client device 102 utilizing a delay-sensitive application for a longer duration than a second radio frequency band 106-N associated with a lower speed wireless client device 102 utilizing a delay-insensitive application. Preferential scheduling can include maintaining an operation of a radio frequency band 106 supporting a delay-sensitive wireless client device 102 application while the application is utilized (e.g., a portion of the duration of utilization, the whole duration of utilization, etc.).

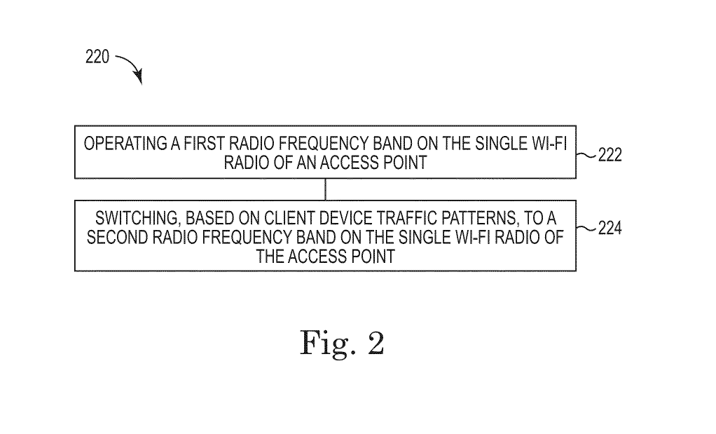

FIG. 2 is a flow chart illustrating an example of a method 220 for multiband operation of a single Wi-Fi radio according to the present disclosure. At 222, the method 220 can include operating a first radio frequency band on the single Wi-Fi radio of an AP. A single Wi-Fi radio can include a Wi-Fi radio that is capable of operating multiple radio frequency bands. For example, the single Wi-Fi radio may be able to operate multiple radio frequency bands, but not two radio frequency bands simultaneously. In some examples, the multiple radio frequency bands may include, for example, the 2.4 GHz and 5 GHz radio frequency bands comporting with IEEE 802.11 standards.

Operating a first radio frequency band on the single Wi-Fi radio can include providing a signal link between the AP and a wireless client device through wireless air interface using the first radio frequency band. For example, operating the first radio frequency band on the single Wi-Fi radio can include providing a signal link between an AP and a wireless client device over a 2.4 GHz radio frequency band. The first radio frequency band can be any radio frequency band comporting with IEEE 802.11 standards.

At 224, the method 220 can include switching, based on client device traffic patterns, to a second radio frequency band on the single Wi-Fi radio of the AP. Switching can include terminating and/or pausing operation of a first radio frequency band on the single Wi-Fi radio and initiating operation of a second radio frequency band. Operating a second radio frequency band on the single Wi-Fi radio can include providing a signal link between the AP and a wireless client device through wireless air interface using a second radio frequency band. For example, operating a second radio frequency band on the single Wi-Fi radio can include providing a signal link between an AP and a wireless client device over a 5 GHz radio frequency radio frequency band. The second radio frequency band can be any radio frequency band, comporting with IEEE 802.11 standards, distinct from the first radio frequency band.

Switching based on wireless client device traffic patterns to the second radio frequency band on the single Wi-Fi radio of the AP can include switching based on traffic load on each radio frequency band. For example, switching based on the traffic load on each radio frequency band can include switching based on the amount of users (e.g., wireless client devices) on each radio frequency band, the number of wireless client devices on each radio frequency band, the technological capabilities of the wireless client devices on each band, the data transmission speeds of wireless client devices on each radio frequency band, and/or packet competition on each radio frequency band, among others. Switching based on traffic load on each radio frequency band can include creating predictive models of the traffic load and/or demand for air time of the single Wi-Fi radio on each radio frequency band based on data associated with the wireless client devices.

Switching based on wireless client device traffic patterns can include switching based on parameters of applications being supported on each radio frequency band. For example, parameters of applications being supported on each radio frequency band can include parameters of an application being utilized by a wireless client device on a particular radio frequency band. By way of example, a smartphone may be utilizing a Voice over Internet Protocol (VoIP) application on a 5 GHz radio frequency band of the AP. In such an example, switching can include switching from operating a 2 GHz radio frequency band to operating a 5 GHz radio frequency band because the 5 GHz radio frequency band is supporting the VoIP application utilized by the smartphone wireless client device of the and the VoIP application requires rapid high-fidelity data transmission to function properly.

The parameters of applications being supported on each radio frequency band can include any number of parameters associated with characteristics of the application. For example, the number of parameters can include the data transmission requirements of an application, the acceptable amount of packet loss associated with an application, the latency of data transmission of the application, the bandwidth requirements of the application, codecs associated with an application, and/or Quality of Service configurations associated with the application. However, the specific parameters are not limited to those listed above, but can include any parameter associated with signal requirements of the application.

The method 220 can include switching between the first radio frequency band and the second radio frequency band on the single Wi-Fi radio of an AP based on wireless client device traffic patterns. This switching can include dynamically switching between the first radio frequency band and the second radio frequency band in order to provide support to wireless client devices on both the first radio frequency band and the second radio frequency band concurrently. For example, switching can include operating a first radio frequency band (e.g., 2.4 GHz) supporting a compatible wireless client device (e.g., student grade laptop, etc.) then switching to a second radio frequency band (e.g., 5 GHz) based on a compatible wireless client device (e.g., smartphone, etc.) associating itself with the AP over the second radio frequency band, thereafter returning to the first radio frequency band in order to operate the first radio frequency band supporting the compatible wireless client device. Thus, the single Wi-Fi radio of the AP can provide a signal link to wireless client devices on both the first radio frequency band and the second radio frequency band concurrently by switching back and forth between the radio frequency bands based on, for example, traffic patterns.

The method 220 can include transmitting beacon packets on at least the first radio frequency band and the second radio frequency band in sequence from the single Wi-Fi radio of the AP. The single Wi-Fi radio of an AP can advertise the existence of multiple service sets (e.g., SSID) on multiple radio frequency bands by transmitting beacon packets on at least the first radio frequency band and the second radio frequency band in sequence from the single Wi-Fi radio of the AP. The single Wi-Fi radio can advertise multiple SSIDs on the same channel of a radio frequency band. In this way, different SSIDs with different security and QoS profiles can be advertised (e.g., one SSID for employee network and one SSID for guest network). The single Wi-Fi radio can also advertise various SSIDs across radio frequency bands. For example, the single Wi-Fi radio can transmit beacon packets corresponding to single and/or various SSIDs on single and/or various channels of a first radio frequency band (e.g., 2.4 GHz radio frequency band) and then can transmit beacon packets corresponding to single and/or various SSIDs on single and/or various channels of a second radio frequency band (e.g., 5 GHz radio frequency band). By alternating transmission (e.g., sequentially by radio frequency band) of beacon packets, the single Wi-Fi radio of an AP can advertise both radio frequency bands to wireless client devices.

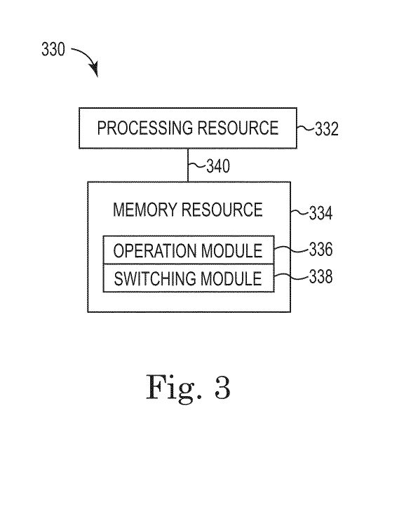

FIG. 3 illustrates a block diagram of an example of a system for multiband operation of a single Wi-Fi radio according to the present disclosure. The system 330 can utilize software, hardware, firmware, and/or logic to perform a number of functions (e.g., operate a first radio frequency band on the single Wi-Fi radio of an access point), etc.). The system 330 can utilize software, hardware, firmware, and/or logic to perform any of the functions discussed in regard to FIG. 1 and FIG. 2.

The system 330 can be any combination of hardware and program instructions configured to perform the number of functions. The hardware, for example, can include a processing resource 332. Processing resource 332 may represent any number of processors capable of executing instructions stored by a memory resource (e.g., memory resource 334, machine readable medium, etc.). Processing resource 332 may be integrated in a single device or distributed across devices. The hardware, for example, can alternatively or additionally include a memory resource 334. Memory resource 334 can represent generally any number of memory components capable of storing program instructions (e.g., machine readable instructions (MRI), etc.) that can be executed by processing resource 332. Memory resource 334 can include non-transitory computer readable media. Memory resource 334 may be integrated in a single device or distributed across devices. Further, memory resource 334 may be fully or partially integrated in the same device as processing resource 332 or it may be separate but accessible to that device and processing resource 332. System 330 may be implemented on a user or client device, on a server device or collection of server devices, or on a combination of the user device and the server device or devices. System 330 can be an AP. For example, system 330 can be an AP analogous to AP 104 discussed with reference to FIG. 1.

In one example, the program instructions can be part of an installation package that when installed can be executed by processing resource 332 to implement system 330. In this example, memory resource 334 can be a portable medium such as a CD, DVD, or flash drive or a memory maintained by a server from which the installation package can be downloaded and installed. In another example, the program instructions may be part of an application or applications already installed. Here, memory resource 334 can include integrated memory such as a hard drive, solid state drive, or other integrated memory devices.

The program instructions (e.g., machine-readable instructions (MRI)) can include a number of modules (e.g., 336 and 338) that include MRI executable by the processing resource 332 to execute an intended function (e.g., operate a first radio frequency band on the single Wi-Fi radio of an access point, operate a second radio frequency band on the single Wi-Fi radio of the access point, etc.). Each module (e.g., 336 and 338) can be a sub-module of other modules. For example, an operation module 336 can be a sub-module and/or contained within the switching module 330. In another example, the number of modules 336 and 338 can comprise individual modules on separate and distinct computing devices.

The operating module 336 can include machine-readable instructions that when executed by the processing resource 332 can operate a first radio frequency band on a single Wi-Fi radio of an access point.

The switching module 338 can include machine-readable instructions that when executed by the processing resource 332 can postpone a wireless client device transmission over the first radio frequency band by modifying a network allocation vector (NAV) of the wireless client device (which can include all wireless client devices utilizing the first radio frequency band) before switching to a second radio frequency band on the single Wi-Fi radio of the access point. The single Wi-Fi radio can be providing a signal link between an AP and a wireless client device over a radio frequency band. The single Wi-Fi radio may be switched to operating a second radio frequency band for various reasons (e.g., sending beacons on the second radio frequency band, providing a signal link between a wireless client device over the second radio frequency band, performing other tasks on the second radio frequency band, etc.). Prior to switching to the second radio frequency band, the single Wi-Fi radio may signal to the wireless client device on the first radio frequency band to postpone all transmissions so that the wireless client device does not attempt to transmit data to the AP while the single Wi-Fi radio is operating the second radio frequency band. Signaling the wireless client device on the first radio frequency band to postpone transmission can be accomplished by modifying a NAV of the wireless client device before switching to the second radio frequency band. For example, the medium access control (MAC) Layer frame headers can contain a Duration field that specifies the transmission time required for a frame and the wireless client devices listening on the radio frequency band can read the Duration field and can set their NAVs accordingly to postpone transmission by the wireless client device for a time sufficient for the single Wi-Fi radio to operate the second radio frequency band. Modifying the network allocation vector of the wireless client device can include distributing the network allocation vector by sending a Clear-To-Send frame (e.g., Clear-to-Send-to-self frame). A Clear-to-Send frame can specify a period of time within which to refrain from attempting to transmit signals to the single Wi-Fi radio (e.g., postpone a wireless client device transmission over a radio frequency band). A Clear-to-Send frame can be distributed on the wireless medium such that is interpreted by all wireless client devices utilizing the wireless medium as an indication that the AP is going to utilize the wireless medium for the next N time units and that the wireless client devices should therefore refrain from transmission to the single Wi-Fi radio for N time units. In general, the Clear-to-Send frame is followed by a data frame. However, the Clear-to-Send frame can be followed by switching to a second radio frequency band on the single Wi-Fi radio of the access point instead.

The switching module 338 can include machine-readable instructions that when executed by the processing resource 332 can postpone a wireless client device transmission over any radio frequency band (e.g., a second radio frequency band) to switch to any other radio frequency band (e.g., the first radio frequency band. For example, the single Wi-Fi radio of an AP can operate a first radio frequency band (e.g., 2.4 GHz radio frequency band) and can postpone a wireless client device transmission (e.g., the transmission of a student grade laptop over the 2.4 GHz radio frequency) by transmitting data capable of modifying a network allocation vector (NAV) of the wireless client device before switching to operating a second radio frequency band (e.g., 5 GHz radio frequency band) to provide a signal link between the AP and a wireless client device (e.g., a smartphone over the 5 GHz radio frequency band). Then, the single Wi-Fi radio of an AP operating a second radio frequency band (e.g., 5 GHz radio frequency band) can postpone a wireless client device transmission (e.g., a smartphone over the 5 GHz radio frequency band) by transmitting data capable of modifying a NAV of the wireless client device before switching back to operating a first radio frequency band (e.g., 2.4 GHz radio frequency band) to provide a signal link between the AP and a wireless client device (e.g., the transmission of a student grade laptop over the 2.4 GHz radio frequency band).

The switching module 338 can include machine-readable instructions that when executed by the processing resource 332 can schedule switching between at least the first radio frequency band and the second radio frequency band based on traffic characteristics on each radio frequency band. Traffic characteristics on each radio frequency band can include wireless client device traffic patterns. Furthermore, traffic characteristic can include a capability of a wireless client device to utilize each radio frequency band. For example, the capability of a wireless client device to utilize each radio frequency band can include the technological capabilities of a wireless client device. The technological capabilities can include the capabilities of the wireless client device to transmit and receive data over a given radio frequency band and/or the transmission speeds that the wireless client device is capable of. For example, switching may be scheduled so that wireless client devices that have the technological capabilities to transmit and receive data over a preferred (e.g., faster) radio frequency band (e.g., 5 GHz) and/or support higher data transmission rates receive greater airtime than those on another radio frequency band (e.g., 2.4 GHz). Scheduling switching can be accomplished by, for example, postponing a wireless client device transmission over any radio frequency band based on traffic characteristics.

Further, traffic characteristics can include a sensitivity of an application to a delay. For example, the sensitivity of an application utilized by a wireless client device and/or supported by a radio frequency band to a delay. This can include the delay sensitivity of an application which a wireless client device has requested to run utilizing a radio frequency band of the single Wi-Fi radio. The sensitivity of a given application can be based on myriad factors. For example, the sensitivity can be based on characteristics associated with the application. These characteristics can include parameters of applications being supported on each radio frequency band including the delay tolerance level (e.g., ability to provide proper functioning of the application under delay conditions) of applications of the type being utilized and/or requested for utilization (e.g., VoIP). For example, switching may be scheduled such that a delay-sensitive application (e.g., VOIP) being utilized by a wireless client device (e.g., smartphone) supported over one radio frequency band (e.g., 5 GHz) will receive more airtime (e.g., more time spent by the single Wi-Fi radio operating the corresponding radio frequency band) than a delay-insensitive application (e.g., Peer to Peer file sharing) operating in another radio frequency band (e.g., 2.4 GHz).

Scheduling switching based on any of the above outlined factors can be a dynamic process. That is, as the traffic and applications associated with a given radio frequency band change, so too can the scheduling. For example, once a delay-sensitive application (e.g., VoIP) is no longer being utilized and/or a wireless client device is no longer present on the WLAN, the switching schedule can be adjusted to account for these changes.

The memory resource 334, as described herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), etc., as well as other types of machine-readable media.

The memory resource 334 can be integral and/or communicatively coupled to a computing device in a wired and/or a wireless manner. For example, the memory resource 334 can be an internal memory, a portable memory, a portable disk, and/or a memory associated with another computing resource (e.g., enabling MRIs to be transferred and/or executed across a network such as the Internet).

The memory resource 334 can be in communication with the processing resource 332 via a communication path 340. The communication path 340 can be local or remote to a machine (e.g., a computer) associated with the processing resource 332. Examples of a local communication path 340 can include an electronic bus internal to a machine (e.g., a computer) where the memory resource 334 is one of volatile, non-volatile, fixed, and/or removable storage medium in communication with the processing resource 332 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 340 can be such that the memory resource 334 is remote from the processing resource 332 such as in a network connection between the memory resource 334 and the processing resources (e.g., 332). That is, the communication path 334 can be a network connection. Examples of such a network connection can include a local area network (LAN), a wide area network (WAN), a personal area network (PAN), and the Internet, among others. In such examples, the memory resource 334 can be associated with a first computing device and a processor of the processing resource 332 can be associated with a second computing device (e.g., a Java® server). For example, a processing resource 332 can be in communication with a memory resource 334, where the memory resource 334 includes a set of MRI and where the processing resource 332 is designed to carry out the set of MRI.

As used herein, “logic” is an alternative and/or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

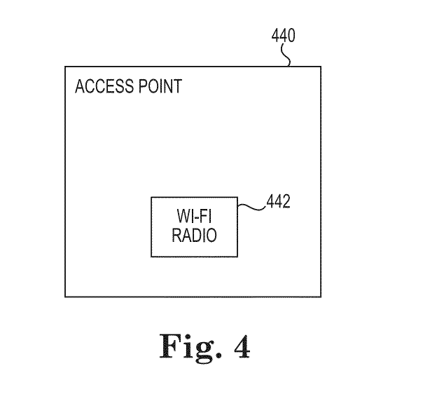

FIG. 4 illustrates a block diagram of an example access point 440 according to the present disclosure. The AP 440 can be analogous to the AP 104 discussed with regard to FIG. 1. The access point 440 can include a single Wi-Fi radio 442 that operates on a first radio frequency band, operates on a second radio frequency band, and switches between the first radio frequency band and second radio frequency band based at least in part on airtime fairness or client device application delay sensitivity.

Switching between the first radio frequency band and the second radio frequency band based on airtime fairness can include scheduling radio frequency band operation based on a transmission rate of the client device on each radio frequency band. Scheduling radio frequency band operation based on a transmission rate of the client device on each radio frequency band can include scheduling shorter operation on a radio frequency band with a high transmission rate client device. Conversely, scheduling radio frequency band operation based on a transmission rate of the client device on each radio frequency band can include scheduling longer operation on a radio frequency band with a high transmission rate client device.

Switching between the first radio frequency band and second radio frequency band based on the client device application delay sensitivity can include scheduling radio frequency band operation based on a type of an application utilized by a client device and a sensitivity of the application to a delay in transmission. Scheduling radio frequency band operation based on a type of application utilized by the client device and the sensitivity of the application to the delay in transmission can include maintaining an operation of a radio frequency band supporting a delay-sensitive client device application while the application is utilized.

Scheduling radio frequency band operation based on a type of application utilized by the client device and the sensitivity of the application to the delay in transmission can include scheduling the switch between the first radio frequency band and the second radio frequency band to occur between transmissions of data (e.g., packets, frames, etc.).

It is to be understood that the descriptions presented herein have been made in an illustrative manner and not a restrictive manner. Although specific examples for systems, methods, computing devices, and instructions have been illustrated and described herein, other equivalent component arrangements, instructions, and/or device logic can be substituted for the specific examples presented herein without departing from the spirit and scope of the present disclosure.

What is claimed is:

1. A method for multiband operation of a single Wi-Fi radio, the method comprising:
operating a first radio frequency band on the single Wi-Fi radio of an access point,
switching, based on client device traffic patterns, to a second radio frequency band on the single Wi-Fi radio of the access point.

2. The method of claim 1, wherein the first radio frequency band comprises a 2.4 Gigahertz radio frequency band and the second radio frequency band comprises a 5 Gigahertz radio frequency band.

3. The method of claim 1, comprising transmitting beacon packets on at least the first and second radio frequency bands in sequence from the single Wi-Fi radio of the access point.

4. The method of claim 1, wherein switching based on client device traffic patterns includes switching based on a traffic load on each radio frequency band.

5. The method of claim 1, wherein switching based on client device traffic patterns includes switching based on parameters of applications being supported by each radio frequency band.

6. A non-transitory machine-readable medium storing a set of instructions that, when executed, cause a processing resource to:
operate a first radio frequency band on a single Wi-Fi radio of an access point; and
postpone a client device transmission over the first radio frequency band by modifying a network allocation vector of the client device before switching to a second radio frequency band on the single Wi-Fi radio of the access point.

7. The medium of claim 6, comprising instructions that, when executed, cause the processing resource to schedule switching between at least the first radio frequency band and the second radio frequency band based on traffic characteristics on each radio frequency band.

8. The medium of claim 7, wherein the traffic characteristics include a capability of the client device to utilize each radio frequency band.

9. The medium of claim 7, wherein the traffic characteristics include a sensitivity of an application to a delay.

10. The medium of claim 6, wherein modifying the network allocation vector of the client device includes distributing the network allocation vector by sending a Clear-To-Send-to-self frame.

11. An access point, comprising:
a single Wi-Fi radio to:
operate a first radio frequency band;
operate a second radio frequency band; and
switch between the first radio frequency band and second radio frequency band based at least in part on airtime fairness or client device application delay sensitivity.

12. The access point of claim 11, wherein the single Wi-Fi radio to switch between the first radio frequency band and second radio frequency band based on airtime fairness includes the single Wi-Fi radio to schedule radio frequency band operation based on a transmission rate of the client device on each radio frequency band.

13. The access point of claim 12, wherein the single Wi-Fi radio to schedule radio frequency band operation based on a transmission rate of the client device on each radio frequency band includes the single Wi-Fi radio to schedule shorter operation on a radio frequency band with a high transmission rate client device.

14. The access point of claim 11, wherein the single Wi-Fi radio to switch between the first radio frequency band and second radio frequency band based on the client device application delay sensitivity includes the single Wi-Fi radio to schedule radio frequency band operation based on a type of an application utilized by a client device and a sensitivity of the application to a delay in transmission.

15. The access point of claim 14, wherein the single Wi-Fi radio to schedule radio frequency band operation based on a type of application utilized by the client device and the sensitivity of the application to the delay in transmission includes the single Wi-Fi radio to schedule maintaining an operation of a radio frequency band supporting a delay-sensitive client device application while the application is utilized.

16. The access point of claim 14, wherein the single Wi-Fi radio to schedule radio frequency band operation based on a type of application utilized by the client device and the sensitivity of the application to the delay in transmission includes the single Wi-Fi radio to schedule the switch between the first radio frequency band and the second radio frequency band to occur between transmissions of packets.
